(19) United States
(12) Patent Application Publication
(10) Pub. No.: US 2024/0026553 A1
(43) Pub. Date: Jan. 25, 2024

(54) REDUCING SYSTEM ENERGY REQUIREMENTS THROUGH FLUID MANIPULATION TO OVERCOME CAPILLARY FORCES OF GAS BUBBLE FORMATION ON REACTIVE SURFACES

(71) Applicant: Marine Dolphin Enterprises, LLC, Scarsdale, NY (US)

(72) Inventors: Bruce Santos, Dresher, PA (US); Michael Kenney, San Francisco, CA (US); Klaus Fahrländer, Baden-Württemberg (DE)

(21) Appl. No.: 18/226,000

(22) Filed: Jul. 25, 2023

Related U.S. Application Data
(60) Provisional application No. 63/392,059, filed on Jul. 25, 2022.
(60) Provisional application No. 63/397,942, filed on Aug. 15, 2022.

(51) Int. Cl. C25B 15/08; C25B 15/023

(52) U.S. Cl. CPC C25B 15/08; C25B 15/023

(57) ABSTRACT

A fluid associated with the desired chemical or electrochemical reaction is continuously flowed or periodically pulsed across a reaction surface at a flow rate or frequency that coincides with the average time needed for a desired proportion of gas bubbles to grow, as part of the reaction, to a specific diameter. The fluid flow rate used is sufficient to break the capillary forces of a bubble on the reaction surface, at the aforementioned specific diameter. If pulsed, during the time period between the periodic fluid flows or pulses, the fluid either does not flow or is at a low enough flow rate to allow for sufficient reaction kinetics. Curving the reactive surface and fluid flow channel can also reduce the surface tension of the bubble, reducing the fluid flow forces required to dislodge the bubbles at optimal sizes, thus reducing energy requirements to pump the fluid.

### REFERENCE TO RELATED APPLICATIONS

This application claims priority and benefit from U.S. Provisional Patent Application 63/392,059, filed Jul. 25, 2022, and U.S. Provisional Patent Application 63/397,942, filed Aug. 15, 2022. The contents and disclosures of each of these applications is incorporated herein by reference in their entirety.

### BACKGROUND

The present invention relates to gas-forming chemical or electrochemical reactions that occur at the contact area between a fluid solution, such as an electrolyte, with a reactive surface, such as an electrode or catalytic material and where the same chemical or electrochemical reaction is not be possible at the contact area between a gas, such as a gas created during the aforementioned reaction, with the same reactive surface.

### SUMMARY

Climate change is one of the largest threats facing the world today. Extreme weather events such as floods, hurricanes, fires and heat waves amongst others are becoming more and more common as the atmosphere continues to be polluted by greenhouse gases generated from the burning of fossil fuels. Therefore, the planet must be provided with alternatives to polluting energy sources and nations with high emissions must transition away from the use of polluting fossil fuels.

Achieving net-zero emissions by the mid to late 21^{st} century has become of the highest importance to the developing and developed world. An integral part of these ambitious goals are carbon-free fuels and energy sources. Renewables, such as solar and wind, are able to provide green electricity, however, the electricity generated is not always able to be stored and available for when the consumer needs to use the electricity, and these energy sources alone cannot quickly, efficiently and at low cost replace fossil fuels.

Hydrogen is a fuel that has the ability to store energy for later use. Hydrogen has many advantages, such as not producing any pollution (its byproduct is water), its ability to be compressed into an energy dense fuel, and its potential to democratize energy availability across the world. Furthermore, hydrogen can store energy as an alternative to large scale batteries or other methods of storing electricity. The development of a strong hydrogen economy would free nations currently dependent on other countries for fossil fuel, and if integrated with renewable energy sources would greatly reduce the carbon footprint of any nation utilizing the fuel.

During chemical or electrochemical reactions that involve the formation of gas bubbles on a surface, typically the gas-forming reaction occurs at the contact area of the reaction's fluid solution, such as an electrolyte, with the surface of interest, such as an electrode. As bubbles grow on the reactive surface they eventually become dislodged, at probability distributed sizes, when the capillary force is exceeded by buoyancy and/or other forces on the bubble. However, as a gas bubble forms on the surface of interest, a reaction is subsequently no longer possible at the contract area between of the gas created during the aforementioned reaction and the surface of interest. In addition, if the reaction's fluid solution is not in contact with the surface of interest for a duration of time sufficient to allow the reaction kinetic to occur, such as would be the case if the solution flowed over the surface at a high flow rate, then gas would not be formed or could be created sub-optimally.

A bubble will detach from a reactive surface when the predominant capillary force (F_{σ}), along with drag force (F_{d}) and inertia force (Fₜ), acting downward are overcome by the predominantly buoyant force (F_{B}), along with gas momentum force (F_{M}) and, if present, capillary shearing force (F_{S}), acting upwards.

It is known that a steady flow of the system's electrolyte has an effect on the efficiency of the electrolysis system. During electrolysis, which involves the formation of hydrogen and oxygen bubbles at the surface of two different electrodes, the formation of bubbles would block the reaction kinetics on the electrode surfaces until the bubbles broke capillary forces naturally or were dislodged from the flow of the electrolyte across the electrodes. Inversely, a high flow of electrolyte would reduce available reaction time and significantly decrease the efficiency of the system.

What has not been addressed in known research is the distribution of bubble sizes when dislodging during the electrochemical reaction, fluidic inefficiencies, the relation of bubble growth rates with fluid pressures, the effects of capillary forces between the bubbles and electrodes, and—specifically— any periodicity of fluid solution flows, detrimental effects of reaction kinetics for the flow rate used, or the ratio of gas-bubble size to available reaction surface area considerations.

Fluid pressures affect the growth rates of bubbles. As pressures are increased, bubble growth rates decrease proportionally which provides a greater probability to successfully time the dislodging of optimally sized bubbles with a pulsed fluid flow.

Fluid flowing within a curved channel will experience higher fluid velocities on the inside curve of a channel relative to the fluid velocity on the outside curve of a channel; and, thus, the curved channel experiences lower fluid pressure on the inside curve of the channel relative to fluid pressure on the outside curve. This pressure differential has been formulated to be

$$\frac{dP}{dr} = ρ \frac{{V}^{2}}{R} \qquad Eq . 1$$

where R is the curve radius, V is the fluid velocity, and ρ is the fluid viscosity.

As a bubble grows in such a curved fluid flow environment there is a resulting pressure differential across the bubble. This results in buoyancy forces directed from high to low pressures, which can reduce the requirement for additional forces to break the capillary forces required to dislodge the bubble from its reactive surface.

The present invention comprises a novel method to reduce system energy requirements by manipulating the formation of gas bubbles on reaction surfaces. A fluid associated with the desired chemical or electrochemical reaction is periodically flowed or pulsed across a reaction surface at a frequency that coincides with the average time needed for a desired proportion of gas bubbles to grow, as part of the reaction, to a specific diameter and at a specific fluid pressure. The fluid flow rate used is sufficient to break the capillary forces of a bubble on the reaction surface, at the aforementioned specific diameter. During the time period between the periodic fluid flows or pulses, the fluid either does not flow or is at a low enough flow rate to allow for sufficient reaction kinetics.

Systems and methods are described herein for targeting an optimal flow rate, pulse frequency and duration of the flowing fluid, and fluid channel designs characteristics to reduce the energy needed to support a gaseous product reaction for any given fluid pressure and viscosity. The optimization of these characteristics can be wholly or partially determined through calculation of reaction kinetics for the gaseous product forming the bubbles on a surface, systematic experimentation to isolate the effects of adjusting each characteristic on energy input versus output, and systematic control of the reaction which adjusts the dynamically controllable input characteristics to optimize the energy output versus energy input.

In some embodiments, at least one of a fluid pressure or a fluid viscosity is determined. For example, one or more sensors placed within the fluid may provide measurements from which the pressure and/or viscosity of the fluid may be determined. A probability distribution of bubble sizes is then selected and an optimal flow rate of the fluid across a surface needed to dislodge bubbles from the reactive surface at the selected probability distribution of bubble sizes is calculated, based on the determined pressure and/or viscosity. The flow rate of fluid across the reactive surface is then adjusted to the optimal flow rate. In some cases, the flow rate of the fluid is adjusted in response to optimizing an energy output measured in relation to a measured energy input.

The reactive surface on which bubbles form may, in some embodiments, be a concave curved surface. Fluid may be continuously pumped within a cavity or fluid channel which is next to and parallel in direction to the concave curved surface curve direction. The cavity or fluid channel may have a sufficient cross-sectional space to allow fluid to flow in a parallel direction to the curved surface area such that fluid flows faster in areas of the cavity or fluid channel that are not nearest to the reactive surface.

In some embodiments, adjusting the flow rate comprises periodically pulsing the fluid across the reactive surface at the optimal flow rate. Between the periodic pulses, the velocity of the fluid flow rate is at or near zero velocity. The periodicity of the pulsed fluid may be increased as the fluid pressure increases at the reactive surface to coincide with, or compensate for, the decreased growth rate of bubbles within the increased fluid pressure.

In some embodiments, the pulsing of the fluid is done by the use of a piston pump, valve actuated fluid channel, peristaltic pump, or other systems that are capable of pulsing a fluid periodically.

In some embodiments, the velocity of the fluid is monitored by a flow meter, at one or both of the inlet and/or outlet, to the system.

In some embodiments, the timing of the pulsing frequency is controlled by monitoring the energy consumption of the system in the form of electric energy (volts, current, and watts) and thermal energy (Kelvin), in proportion to the fluid pressure of the reaction.

### BRIEF DESCRIPTION OF THE DRAWINGS

The above and other objects and advantages of the present disclosure will be apparent upon consideration of the following detailed description, taken in conjunction with the accompanying drawings, in which like reference characters refer to like parts throughout, and in which:

FIG. 1 shows bubbles of increasing size as they dislodge from a reactive surface;

FIG. 2 is a cross-section of a fluid enclosed compartment that contains a reactive surface that chemically, or electrochemically, produces gaseous bubbles and a fluid flow that creates sheering force; in accordance with some embodiments of the disclosure;

FIG. 3 is a cross-section of a fluid enclosed compartment that contains a concaved curved reactive surface that chemically, or electrochemically, produces gaseous bubbles and a fluid flow that creates both a sheering force and additional buoyancy force, in accordance with some embodiments of the disclosure;

FIG. 4 shows design considerations for a curved electrolyser, in accordance with some embodiments of the disclosure;

FIG. 5 is an example electrolyser design showing fluid channels and a curved reactive surface area, in accordance with some embodiments of the disclosure;

FIG. 6 shows an example of an apparatus for creating gas from an electrolysis process, in accordance with some embodiments of the disclosure;

FIG. 7 is a flowchart representing an illustrative process for optimizing the fluid flow rate across a reactive surface, through monitoring of energy inputs and the energy content of the gas produced, in accordance with some embodiments of the disclosure; and

FIG. 8 is a flowchart representing an illustrative process for optimizing the fluid pulse frequency, in accordance with some embodiments of the disclosure.

### DETAILED DESCRIPTION

The present disclosure is directed at a fluid enclosed compartment that contains a reactive surface that chemically, or electrochemically, produces gaseous bubbles on said surface. The enclosed fluid is required and contributes to the chemical or electrochemical reaction, such as an electrolytic fluid. The reactive surface can consist of a catalyst that reacts with the fluid chemically, or the reactive surface can be an anode or cathode with a specifically applied voltage and current required to react with the enclosed fluid electrochemically, with or without heat, radiation or other related energy sources exhibited within the electromagnetic spectrum needing to be applied to the system to support the reaction at the reactive surface.

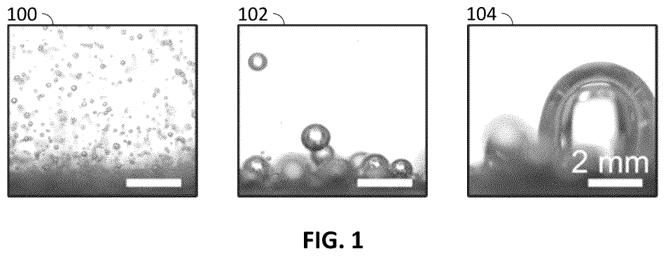

Referring to FIG. 1 there are shown images, at the same scale, of bubbles forming and dislodging from a reactive surface. From left to right, 100 shows bubbles growing under a condition that required relatively lower energy consumption than 102, which in turn shows bubble growing under a condition that required relatively lower energy consumption than 104. As can be observed in 100, the bubbles growing on the reactive surface dislodge at a smaller size than 102, which in turn shows bubbles growing on the reactive surface dislodge at a smaller size than 104. The images in FIG. 1 demonstrate the energy consumption benefits of smaller bubble sizes growing on reactive surfaces.

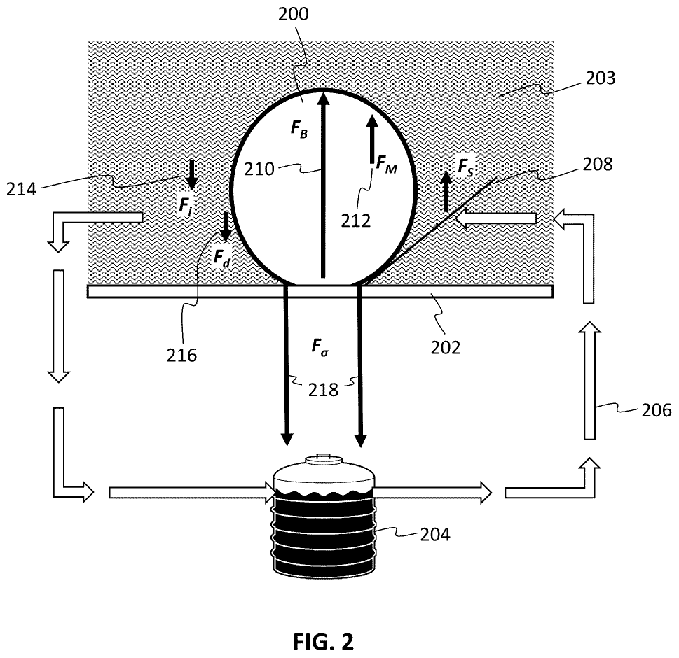

Referring now to FIG. 2, there is shown a cross-section of a fluid enclosed compartment that contains a reactive surface that chemically, or electrochemically, produces gaseous bubbles that is typical of a reaction chamber. Bubble 200 is shown forming on reactive surface 202. All the area outside of the bubble, and above the reactive surface, consists of a fluid required to support the chemical, or electrochemical, reaction—such as an electrolyte 203. The chemical, or electrochemical, reaction occurs that the point of contact between the gaseous bubble 200, the reactive surface 202, and the fluid 203. Also shown is a representation of flow of the fluid 206, from right to left. There are several forces on the bubble, which affect the conditions at which bubble 200 will dislodge from the reactive surface 202.

Capillary forces (F_{σ}) 218 hold the bubble on the surface, at the point of contact between the gaseous bubble 200, reactive surface 202, and fluid required 203 to support the reaction. This is sometimes referred to as surface tension. Two downward forces are shown 218, to indicate the combined capillary force holding the bubble on the reactive surface. This is influenced by the composition of the reactive surface, the composition of the gas of the bubble, and the characteristics of the fluid.

Inertia force (Fᵢ) 214 is required to be overcome if the bubble is to start moving upwards, in the direction of buoyancy. This is a downwards force.

Drag force (F_{d}) 216 is also required to be overcome if the bubble is to start moving through the fluid 203. This is a downwards force and is predominantly influenced by the viscosity of the fluid.

Buoyant force (F_{B}) 210 is an upward force proportional to the volume of the bubble 200 in a denser fluid 203, minus the weight of the bubble. It is based on the summation of hydrostatic forces distributed across the entire surface of a bubble, from top to bottom, where such fluid-based pressures at the top of bubble are slightly lower than the hydrostatic pressures at the bottom, resulting in a net upwards force vector.

Gas momentum force (F_{M}) 212 occurs as the bubble is growing and is based on the velocity of the gas, and its related momentum, while expanding the bubble 200. The faster the bubble grows, the larger the force. As the bubble is anchored on a surface, the gas momentum forces are generally in directions away from the reactive surface. The net vector forces in the upward direction are shown.

Sheer force (F_{S}) 208 is present when the bubble is exposed to lateral forces exerted from a one direction flow of the surrounding fluid. As the lateral force pushes on one side of the bubble it creates a fulcrum scenario that provides an upward force. This force increases with greater fluid velocities.

Fluid flow 206 is shown going across the reactive surface right to left, commencing with the wavy lines, providing necessary fluid to support the reaction at the reactive surface, providing the aforementioned sheering force to bubbles growing, and circulating through piping, tubing or otherwise, to a reservoir, tank, or otherwise 204, and then circulated back to the reactive surface. While the fluid is within the reservoir, tank or otherwise 204 the chemical nature of the fluid may be analyzed and the appropriate chemical, treatments or otherwise may be added to the fluid.

The objective is to provide sufficient sheer force, and in some embodiments additional buoyancy force, to dislodge the bubble, at the optimal system efficiency, through manipulation of the fluid flow.

In some embodiments the reactive surface, and fluid channel above the reactive surface, is tightly curved concavely, in one dimension, with the fluid flowing across the reactive surface in the same direction of the concave curve in fluid channels that have a height, from the surface of the reactive surface upwards, that is at least 2.5× the diameter of the calculated bubble size coinciding with the continuous flow rate of an optimal energy output over inputs ratio determined by the aforementioned process. The objective is to provide greater differential pressure between the bottom of the bubble, at the reactive surface, and the top of the bubble due to a higher flow rate at the top of the channel. This greater differential pressure contributes more to the buoyancy force, requiring less net fluid velocity across the reactive surface to dislodge the bubble, and thus less external energy to run fluid pumps.

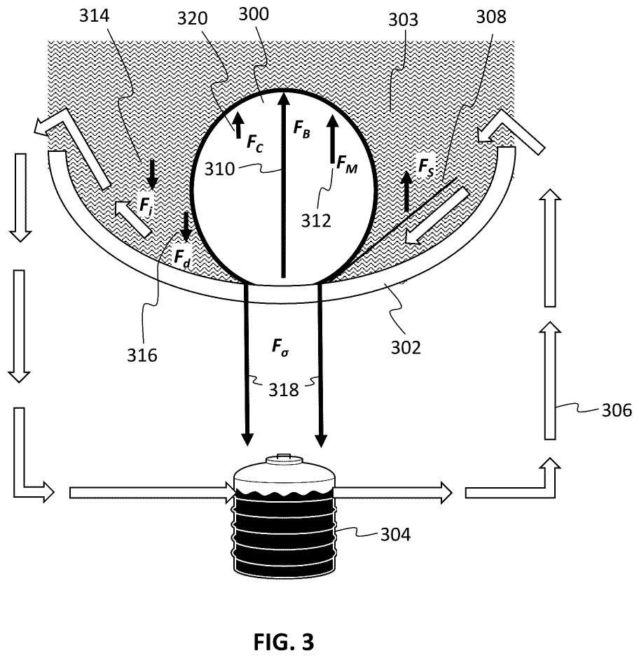

In like manner, referring now to FIG. 3, there is shown a cross-section of a fluid enclosed compartment that contains a curved reactive surface that chemically, or electrochemically, produces gaseous bubbles that is typical of a reaction chamber. Bubble 300 is shown forming on the reactive surface 302. All the area outside of the bubble, and above the reactive surface, consists of a fluid required to support the chemical, or electrochemical, reaction—such as an electrolyte 303. The chemical, or electrochemical, reaction occurs that the point of contact between the gaseous bubble 300, the reactive surface 302, and the fluid 303. Also shown is a representation of flow of the fluid 306, from right to left. Several forces on the bubble, which affect the conditions at which point the bubble 300 will dislodge from the curved reactive surface 302. These consist of the same forces noted in FIG. 2, but with one addition (320).

Capillary forces (F_{σ}) 318 hold the bubble on the surface, at the point of contact between the gaseous bubble 300, reactive surface 302, and fluid required 303 to support the reaction. This is sometimes referred to as surface tension. Two downward forces are shown 318, to indicate the combined capillary force holding the bubble on the reactive surface. This is influenced by the composition of the reactive surface, gas of the bubble, and the characteristics of the fluid.

Inertia force (Fᵢ) 314 is required to be overcome if the bubble is to start moving upwards, in the direction of buoyancy. This is a downwards force.

Drag force (F_{d}) 316 is also required to be overcome if the bubble is to start moving through the fluid 303. This is a downwards force and is predominantly influenced by the viscosity of the fluid.

Buoyant force (F_{B}) 310 is an upward force proportional to the volume of the bubble 300 in a denser fluid 303, minus the weight of the bubble. It is based on the summation of hydrostatic forces distributed across the entire surface of a bubble, from top to bottom, where such fluid-based pressures at the top of bubble are slightly lower than the hydrostatic pressures at the bottom, resulting in a net upwards force vector.

An additional buoyant force cause by the curved flow of the fluid (F_{C}) 320, is an upward force which are caused by fluid flow being channeled to follow the curved reactive surface 302, at decreasing radii from bottom to top, with calculated decreasing fluid pressure, from bottom to top, following Equation 1 above, where R is the curve radius of the fluid at a point in the fluid flow channel, V is the fluid 306 velocity, and p is the fluid 306 viscosity. This creates additional fluid pressure differences, between the bottom and top of the bubble, that would not be present if the fluid channel had no radius.

Gas momentum force (F_{M}) 312 occurs as the bubble is growing and is based on the velocity of the gas, and its related momentum, while expanding the bubble 300. The faster the bubble grows, the larger the force. As the bubble is anchored on a surface, the gas momentum forces are generally in directions away from the reactive surface. The net vector forces in the upward direction are shown.

Sheer force (F_{S}) 308 is present when the bubble is exposed to lateral forces exerted from a one direction flow of the surrounding fluid. As the lateral force pushes on one side of the bubble it creates a fulcrum scenario that provides an upward force. This force increases with greater fluid velocities.

Fluid flow 306 is shown going across the curved reactive surface right to left, commencing with the wavy lines, providing necessary fluid to support the reaction at the reactive surface, providing the aforementioned sheering force to bubbles growing, and circulating through piping, tubing or otherwise, to a reservoir, tank, or otherwise 304, and then circulated back to the reactive surface. While the fluid is within the reservoir, tank or otherwise 304 the chemical nature of the fluid may be analyzed and the appropriate chemical, treatments or otherwise may be added to the fluid.

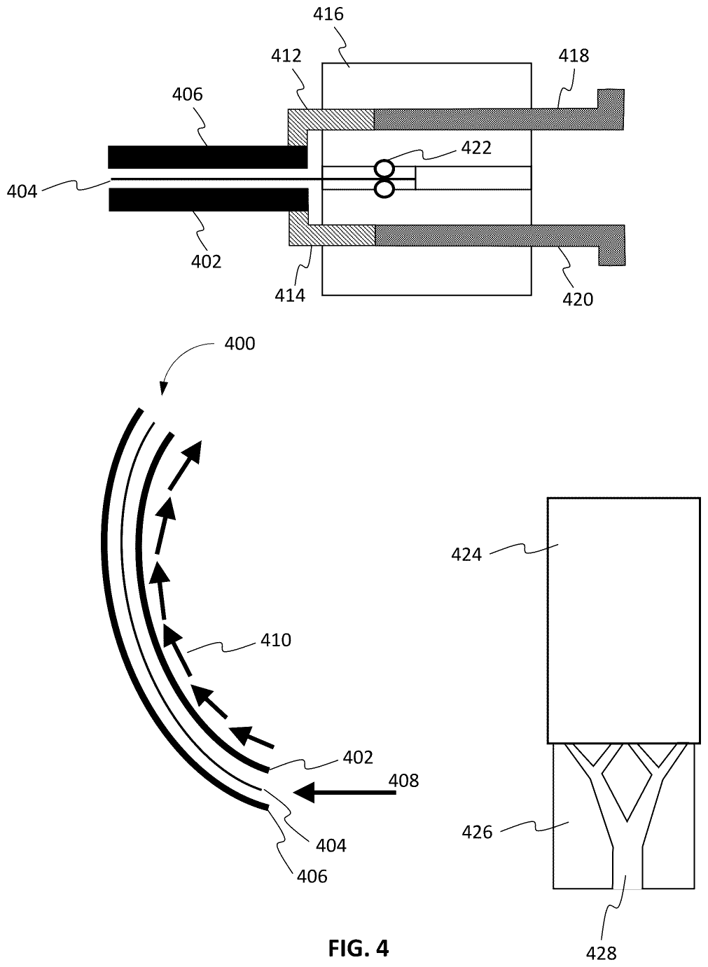

Referring now to FIG. 4, design considerations are shown for an electrochemically driven system that produces gaseous bubbles grown on a reactive surface within a fluid. A cross section of curved system design is shown with a membrane 404 separating two electrodes, at 402 and 406, and with the electrolytic fluid flow 410 across one of the electrodes 402.

Interfacing design considerations are also shown at the cross-sectional end 400 showing a structure 416 supporting electrical connections, at 418 and 420, from outside a fluid camber to the inside where the same electrical connections are treated with a non-reactive surface coating, at 412 and 414, for use inside the fluid chamber and further electrical connection to the electrodes, at 406 and 402. To support the electrochemical system reactions, and to help ensure fluid and/or gas separation between the two reactive surfaces of the electrodes, at 406 and 402, the membrane 404 has seals 422 between the supporting structure 406 and either side of the membrane 404 to further ensure fluid and/or gas separation between the two reactive surfaces of the electrodes.

Design considerations for the fluid flow entering the reactive chamber of the system 408 are also shown being channeled and distributed 428 through the supporting structure 426 in relation to an electrode 424, looking down on a reactive surface. The fluid is distributed 428 from a single-channel inlet and bifurcated several times to present the fluid, at nearly the same pressure and flow rate, across the entire bottom edge of the electrode 424 in this representation, traversing the reactive surface of the electrode 424 from bottom to top.

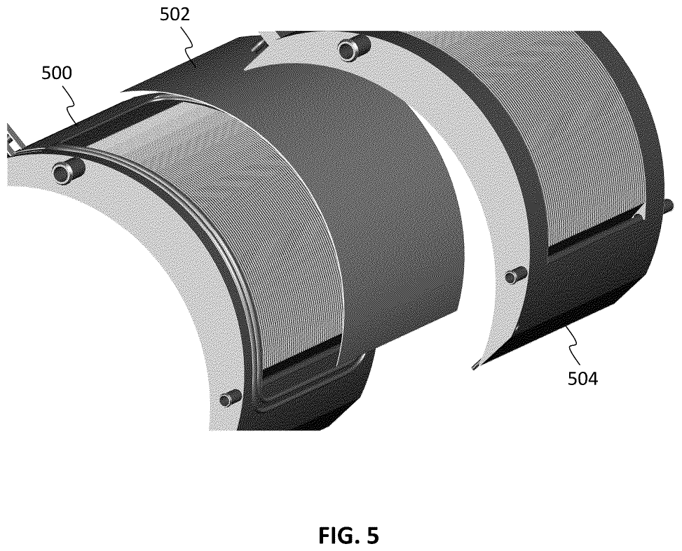

Referring now to FIG. 5, and example electrolyser is represented as a three dimensional view showing a curved supporting structure 500, with curved fluid channels incorporated therein, having a reactive surface or electrode 502 placed between one curved structure 500 and another identical curved structure 504. It should be understood that the three dimensional representation shown in FIG. 5 is merely an illustrative example of a curved fluid channel in an electrolyser. Other designs are possible, including variations in support structures, dimensions, curve radius, etc., and all such variations are contemplated by, and fall within the scope of, this disclosure.

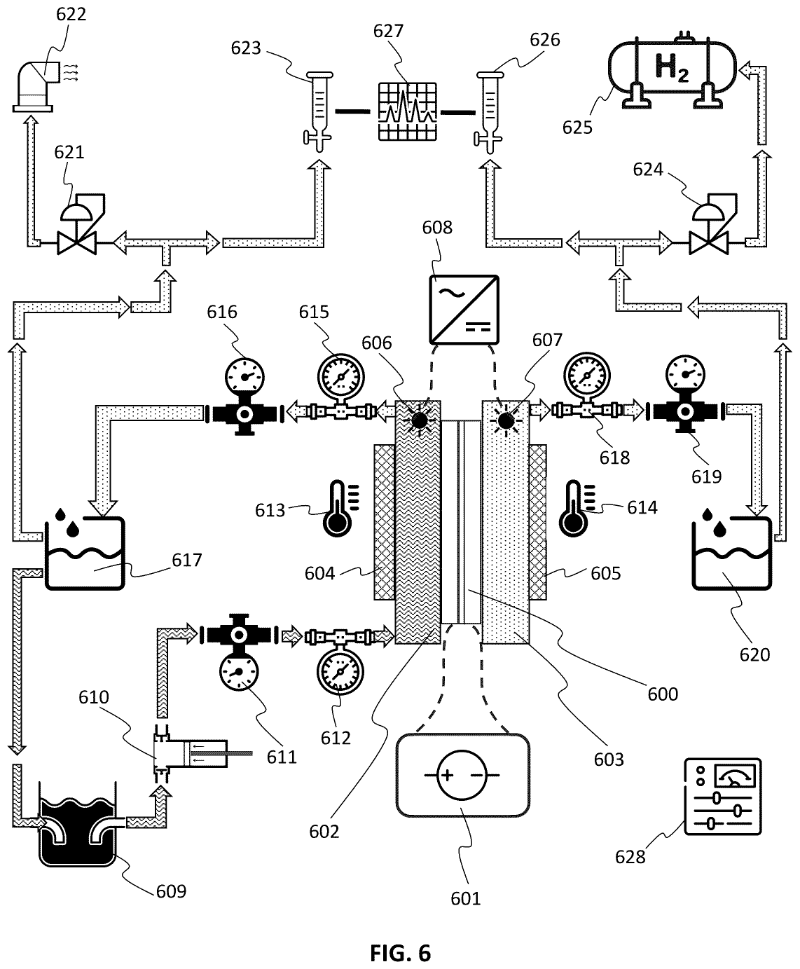

Referring now to FIG. 6, a single cell electrolyser is shown with various system controllers, measuring instruments, fluid and gas flows, and system supporting processes without a supporting structure. The center of the electrolyser is a combination of an anode, cathode and membrane separator 600. The anode and cathode are connected to a potentiostat 601, which provides both electrical energy to support the electrochemical reaction of the electrolyser, and also measures the electrical energy consumed by the electrolyser. Electrolytic fluid 602 is exposed to, or pumped across, the anode from bottom to top in this representation. To support or enhance the electrochemical reaction the fluid, and electrolyser, can be heated 604 and a thermometer 613 can be used to facilitate control of the heater 604 and/or measure exothermic heat produced from the electrolyser, at the anode. To support or enhance the electrochemical reaction the fluid 602 can be radiated by a source of electromagnetic energy 606 energized, controlled and monitored by an apparatus 608. During the electrochemical reaction the anode produces gaseous by-products, that are solely or predominantly oxygen, which are bubbled or dissolved into the fluid 602.

The cathode produces predominantly hydrogen gas, which is captured as a gas 603, or bubbled or dissolved, into a fluid. To support or enhance the electrochemical reaction the gas, fluid, or electrolyser, can be heated 605 and a thermometer 614 can be used to facilitate control of the heater 605 and/or measure exothermic heat produced from the electrolyser, at the cathode. To support or enhance the electrochemical reaction the gas or fluid 603 can be radiated by a source of electromagnetic energy 607 energized, controlled and monitored by an apparatus 608.

Electrolytic fluid is stored within the reservoir, tank or otherwise 609 where the chemical nature of the fluid may be analyzed and the appropriate chemical, treatments or otherwise may be added to the fluid. The electrolytic fluid is pumped from the reservoir 609 using a pump 611, such as a piston pump, a valve actuated pressurization system, peristaltic pump, or other systems that are capable of pulsing a fluid periodically. The electrolytic fluid entering the electrolyser is monitored and controlled for flow rate 611 and pressure 612.

Electrolytic fluid 602 exiting the anode side of the electrolyser is monitored and controlled for flow rate 616 and pressure 615, before having gas and liquid being separated 617. Electrolytic fluid separated from the gas is then sent to the reservoir 609. Separated gas, with is predominantly oxygen, is vented 622 or used elsewhere after being monitored and controlled by a back pressure regulator 621. A part of the separated gas, with is predominantly oxygen, is sent through a mass flow controller 623 before being analyzed by a gas chromatograph or similar system 627.

Gas 603 or fluid existing the cathode side of the electrolyser is monitored and controlled for flow rate 619 and pressure 618, before having gas and liquid being separated 620. Separated gas, with is predominantly hydrogen, is stored 625 or transported elsewhere after being monitored and controlled by a back pressure regulator 624. A part of the separated gas, with is predominantly hydrogen, is sent through a mass flow controller 626 before being analyzed by a gas chromatograph or similar system 627.

A system controller 628 monitors and controls all inputs used by the electrolyser, including the potentiostat 601, electrolytic fluid reservoir 609, pump 611, inbound electrolytic fluid flow 611 and pressure 12, anode heating 604, cathode heating 605, and the consumption used by other electromagnetic radiate sources (606, 607) being controlled and monitored 608. System controller 628 may be based on any suitable processing circuitry and comprises control circuitry and memory circuitry, which may be disposed on a single integrated circuit or may be discrete components. As referred to herein, processing circuitry should be understood to mean circuitry based on one or more microprocessors, microcontrollers, digital signal processors, programmable logic devices, filed-programmable gate arrays (FPGAs), application-specific integrated circuits (ASICs), etc., and may include a multi-core processor (e.g., dual core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The system controller 628 adjusts the inputs based on the aforementioned input measurements, and outputs measurements of electric energy consumption 601, outbound gas and fluid flow rates (616, 619), outbound gas and fluid pressures (615, 618), and gas chromatograph 627 measured values for all gases analyzed. System controller 628 may receive these measurements through wired or wireless connections. For example, system controller 628 may include a transceiver or data bus for communicating with various sensors through any suitable wired or wireless data protocol (e.g., Ethernet, USB, Wi-Fi, Bluetooth, etc.)

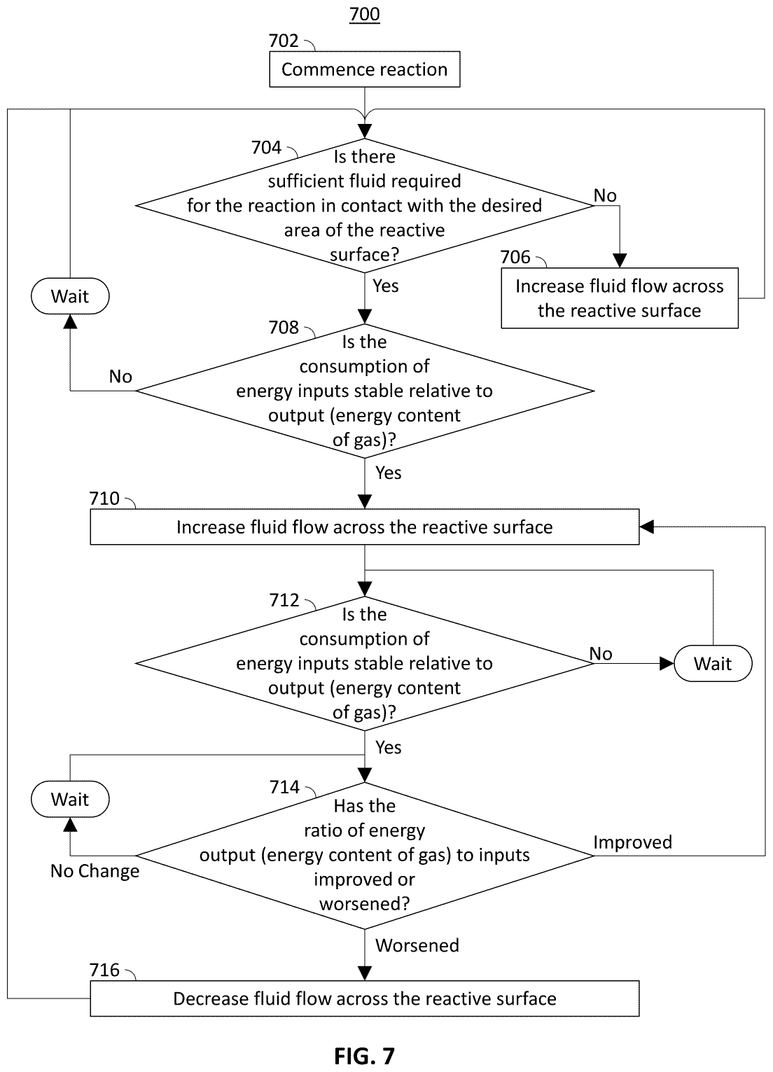

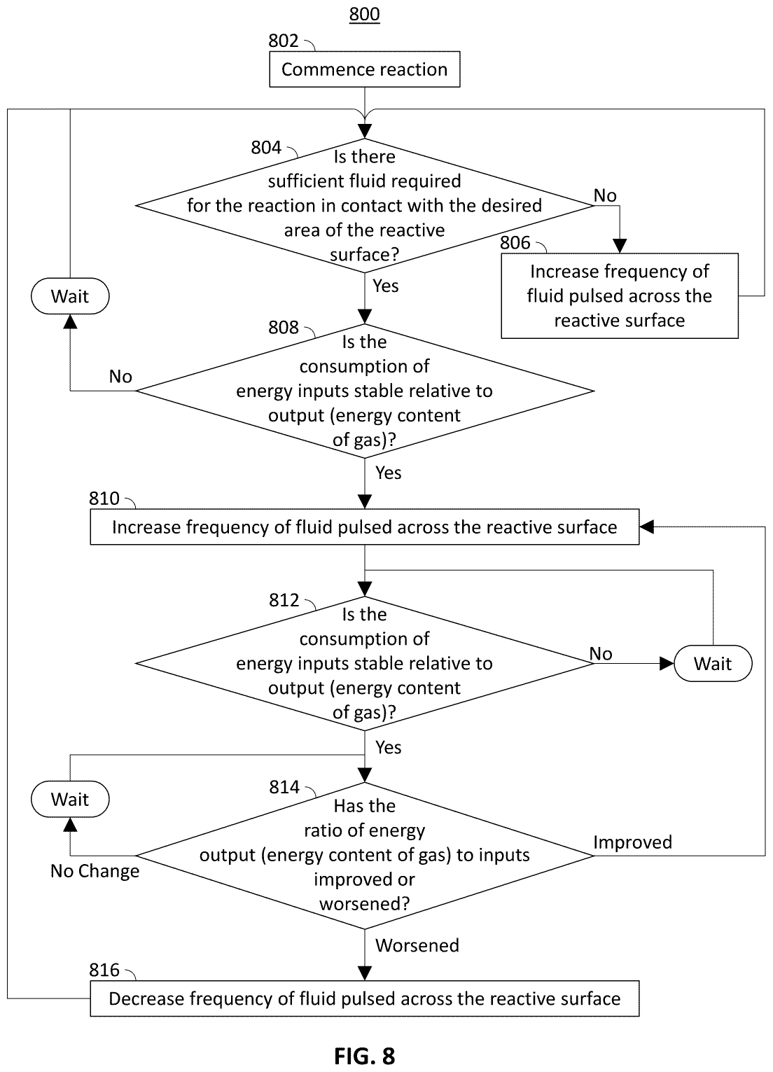

Minimum and maximum thresholds are set within the system controller 628 based on pre-defined limitations of the pressure, flow rate, temperature and energy consumption of components and apparatus used within the system. Given different fluid pressures for the gaseous product reaction targeted for the system, the controller logic is baselined using a fluid flow rate experimented with and derived from the process discussed below in connection with FIG. 7. During normal operation, the controller logic includes the same process. If a pulsed fluid strategy targeted for the system operation, the controller logic is baselined using a fluid pulse frequency experimented with and derived from the process discussed below in connection with FIG. 8. During normal operation, the controller logic includes the same process.

Referring now to FIG. 7, the system requires pre-determined calculations for energy inputs, such as voltage, current, heat, radiation or other related energy sources exhibited within the electromagnetic spectrum needing to be applied to the system to support the chemical or electrochemical reaction at the reactive surface, as baseline for the system efficiency. Such calculations may need consideration for fluid pressure effects on the energy input requirements—particularly if slowing bubble growth is a system objective. It is also required that a reaction fluid consumption rate be calculated and be converted to a minimum fluid flow rate into the system, based on the net area of the reactive surface, to ensure that the reaction will not be starved.

The chemical or electrochemical reactions is commenced 702 within the reaction chamber using energy inputs expected for the reaction, with a fluid flow rate matching what the reaction is expected to consume. The reaction surface is monitored for sufficient fluid 704, by means of a liquid level gauge, a capacitive sensor tuned for liquid level measuring, or by monitoring for thermal anomalies emanating from the reaction surface, which would indicate that the reaction is being starved of fluid. If there is insufficient fluid being fed to the reactive surface (“No” at 704), then, at 706, the flow rate is increased. If there is sufficient fluid being fed to the reactive surface (“Yes” at 704), then all energy inputs are then monitored relative to the output in terms of the energy content of the produced gas, which may be derived from the volume and pressure of gas being produced 708. If the energy inputs and outputs are not stable (“No” at 708), in some embodiments a wait period can be applied, otherwise the aforementioned monitoring at 704 and 708 continues.

If the energy inputs and outputs are stable (“Yes” at 708), a baseline ratio of energy output to energy inputs is recorded, the fluid flow rate is increased at 710, and energy inputs and outputs are monitored for stability after the increase in flow rate 712. If consumption of energy input is not stable relative to energy output (“No” at 712), in some embodiments a wait period can be applied. Once the consumption of energy input relative to energy output is stable (“Yes” at 712), with the increased flow rate, the ratio of energy output to inputs is compared to previous recording 714. If the energy ratio has improved (“Improved” at 714), the fluid flow rate is increased 710 and monitoring continues. If the energy ratio has worsened (“Worsened” at 714), the fluid flow rate is decreased 716, and the reaction surface is monitored for sufficient fluid 704 before continuing with the aforementioned processes. If there is no change in the ratio (“No Change” at 714), in some embodiments a wait period can be applied.

In some embodiments the reactive system process is commenced by pulsing the fluid at a very high flow rate at a frequency whose time period matches the calculated bubble growth time coinciding with the continuous flow rate of an optimal energy output over inputs ratio determined by the aforementioned process. The duration of the pulse is determined by experimentation that involved monitoring the flow rate leaving the reactive surface, or reactive chamber prior to recirculation, and setting the optimal continuous flow rate previously determined as the end of the fluid pulse period. Due to inertial delays of the fluid between the end of the pulse, and measuring of the ending flow rate, the duration of the pulse may have to be decreased until the observed fluid flow rate exiting the reactive surface matches the optimal continuous flow rate for the system. FIG. 8 is a flowchart representing an illustrative process for optimizing frequency of the fluid to be pulsed across the reactive surface, which follows the same process as FIG. 7 except instead of the flow rate being increased or decreased in some processes, it is the frequency of the high flow rate pulse is increased or decreased.

In some embodiments the pulsing of the fluid, as described above and in FIG. 8, provides the starting conditions for FIG. 7, in terms of pulsing the fluid at a fixed frequency and duration, and the flow rate per pulse is optimized by following the remaining process within FIG. 7.

What is claimed is:

1. A method of optimizing a gas-forming chemical or electrochemical reaction, comprising:
determining at least one of a pressure of a fluid or a viscosity of the fluid;
selecting a probability distribution of bubble sizes;
calculating, based on the determining, an optimal flow rate of the fluid, across a reactive surface, needed to dislodge bubbles from the reactive surface at the selected probability distribution of bubble sizes; and
adjusting the flow rate of the fluid, across the reactive surface, to the optimal flow rate,
wherein:
during the gas-forming chemical or electrochemical reaction, gas bubbles will form on the reactive surface; and
the fluid is required for the gas-forming chemical or electrochemical reaction.

2. The method of claim 1, further comprising:
optimizing an energy output measured in relation to energy input measured,
wherein the adjusting of the flow rate of the fluid, across the reactive surface, is done in response to optimizing the energy output.

3. The method of claim 1, wherein the reactive surface is a concave curved surface, the method further comprising:
continuously pumping the fluid within a cavity or fluid channels, next to and parallel in direction to the concave curved surface curve direction, the cavity or fluid channels also being concave in shape and having sufficient cross-sectional space to allow fluid to flow in a parallel direction to the curved reactive surface area such that fluid flows faster in areas of the cavity or fluid channel that are not nearest to the reactive surface.

4. The method of claim 1, wherein adjusting the flow rate of the fluid comprises periodically pulsing the fluid, across the bubble forming reactive surface, at the optimal flow rate to dislodge bubbles from the reactive surface and wherein the flow rate between the periodic pulses is at or near zero velocity.

5. The method of claim 4, wherein a periodicity of the pulsed fluid is increased as the fluid pressure is increased at the reactive surface to coincide with the decreased growth rate of bubbles within increased fluid pressure.

6. The method of claim 4, wherein the pulsing of the fluid is done using a piston pump.

7. The method of claim 4, wherein the pulsing of the fluid is done using a valve actuated fluid channel.

8. The method of claim 4, wherein the pulsing of the fluid is done using a peristaltic pump.

9. The method of claim 4, further comprising controlling the periodicity of the pulsing of the fluid by monitoring an energy consumption in the form of electric energy and thermal energy, in proportion to the fluid pressure.

10. The method of claim 1, further comprising:
monitoring a velocity of the fluid,
wherein the velocity of the fluid is monitored by a flow meter and at least one of a fluid inlet or a fluid outlet.

11. A system for optimizing a gas-forming chemical or electrochemical reaction, comprising:
a reactive surface on which gas bubbles will form during the gas-forming chemical or electrochemical reaction;
a fluid required for the gas-forming chemical or electrochemical reaction; and
control circuitry configured to:
determine at least one of a pressure of a fluid or a viscosity of the fluid;
select a probability distribution of bubble sizes;
calculate, based on the determining, an optimal flow rate of the fluid, across the reactive surface, needed to dislodge bubbles from the reactive surface at the selected probability distribution of bubble sizes; and
adjust the flow rate of the fluid, across the reactive surface, to the optimal flow rate.

12. The system of claim 11, wherein the control circuitry is further configured to:
optimize an energy output measured in relation to energy input measured,
wherein the control circuitry configured to adjust of the flow rate of the fluid, across the reactive surface, is configured to do so in response to optimizing the energy output.

13. The system of claim 11, wherein the reactive surface is a concave curved surface, and wherein the control circuitry is further configured to:
continuously pump the fluid within a cavity or fluid channels, next to and parallel in direction to the concave curved surface curve direction, the cavity or fluid channels also being concave in shape and having sufficient cross-sectional space to allow fluid to flow in a parallel direction to the curved reactive surface area such that fluid flows faster in areas of the cavity or fluid channel that are not nearest to the reactive surface.

14. The system of claim 11, wherein the control circuitry configured to adjust the flow rate of the fluid is further configured to periodically pulse the fluid, across the bubble forming reactive surface, at the optimal flow rate to dislodge bubbles from the reactive surface and wherein the flow rate between the periodic pulses is at or near zero velocity.

15. The system of claim 14, wherein the control circuitry is further configured to increase a periodicity of the pulsed fluid as the fluid pressure is increased at the reactive surface to coincide with the decreased growth rate of bubbles within increased fluid pressure.

16. The system of claim 14, wherein the pulsing of the fluid is done using a piston pump.

17. The system of claim 14, wherein the pulsing of the fluid is done using a valve actuated fluid channel.

18. The system of claim 14, wherein the pulsing of the fluid is done using a peristaltic pump.

19. The system of claim 14, wherein the control circuitry is further configured to control the periodicity of the pulsing of the fluid by monitoring an energy consumption in the form of electric energy and thermal energy, in proportion to the fluid pressure.

20. The system of claim 11, wherein the control circuitry is further configured to:
monitor a velocity of the fluid,
wherein the control circuitry monitors the velocity of the fluid using a flow meter at at least one of a fluid inlet or a fluid outlet.
